(19) United States
(12) Patent Application Publication
(10) Pub. No.: US 2021/0039211 A1
(43) Pub. Date: Feb. 11, 2021

(54) MULTIPLE SPINDLE MACHINE TOOL

(71) Applicant: OKUMA CORPORATION, Niwa-gun (JP)

(72) Inventor: Yasuki Izui, Niwa-gun (JP)

(21) Appl. No.: 16/986,715

(22) Filed: Aug. 6, 2020

(30) Foreign Application Priority Data
Aug. 8, 2019 (JP) 2019-146210

(51) Int. Cl. B23Q 3/157; B23Q 3/16

(52) U.S. Cl. CPC B23Q 3/157; B23Q 2220/004; B23Q 2220/002; B23Q 3/16

(57) ABSTRACT

Provided is a multiple spindle machine tool which is capable of sufficiently preventing tool exchange failure due to cutting chips and improving the freedom of machine operation. A left and right magazines are provided in the tool storage chamber as an automatic tool changer corresponding to a left and right spindles. A right and left shutters, each of which is arranged to open and close as the left and right spindles enter and exit between the machining chamber and the tool storage chamber, are provided for each of the spindles.

### TECHNICAL FIELD

The present invention relates to a machine tool, and in particular to a multiple spindle machine tool having a plurality of spindles.

### BACKGROUND ART

In a machine tool having a machining chamber and a tool enclosure, the number of spindles is normally considered to be one, but a multiple spindle machine tool having two or more spindles is also known (Patent Document 1). In a multiple spindle machine tool, productivity is enhanced by constant machining with a particular spindle.

In Patent Document 1, two tool exchange arms are used for two spindles, one ATC shutter is opened and closed when the spindles enter and exit between the machining chamber and the tool storage chamber, and one magazine is used for storing the exchange tool.

As an automatic tool changer (ATC) for a machine tool, there are known an ATC using the tool exchange arm or an ATC not using the tool exchange arm (an armless ATC).

### CITATION LIST

### Patent Literature

Patent Literature 1: Japanese Patent Application Laid-Open No. 2000-326171

### SUMMARY OF INVENTION

### Technical Problem

In a multiple spindle machine tool that operates an automatic tool change without the use of a tool exchange arm, machining is always performed on a specific spindle. Therefore, the ATC shutter cannot be closed during the operation of a tool exchange for the spindle which requires the tool exchange after machining is completed.

Accordingly, there was a problem that foreign substances, such as cutting chips generated during machining, adhered to the taper of the spindle or the taper of the tool, which required the tool exchange after finishing machining, and caused a tool exchange malfunction.

In addition, in order to avoid the problem caused by the cutting chips, it was necessary to exchange tools of a plurality of spindles by ATC operation at the same time, which is a constraint on machine operation.

The object of the present invention is to provide a multiple spindle machine tool which prevent defective tool exchange operation due to cutting chips and also improve freedom in machine operation.

### Solution to Problem

Multiple spindle machine tool according to the present invention include a plurality of spindles, a machining chamber, a tool storage chamber, a plurality of automatic tool changers (ATCs), and a plurality of shutters, each of which is arranged to open and close when each of the plurality of spindles enters and exits between the machining chamber and the tool storage chamber, wherein each ATC is corresponding to each of the plurality of spindles and each shutter is provided for each of the plurality of spindles.

According to the multiple spindle machine tool of the present invention, each shutter is normally in a closed position, and when either spindle is switched from machining to machining by another spindle, the corresponding shutter can be moved to an open position only when each spindle enters and exits the machining chamber and the tool chamber, and each other shutter can be maintained in a closed position.

Accordingly, cutting chips generated during machining are prevented from entering the tool storage chamber and tool exchange failure due to cutting chips is prevented.

Here, since the spindle after tool exchange may stand by in the machining chamber or may stand by in the tool storage chamber, the spindle waiting in the machining chamber and the workpiece may be prevented from interfering with each other, thereby allowing expansion of the machining area.

In addition, since each ATC is provided in the tool storage chamber corresponding to each of the plurality of spindles, tools for each of the plurality of spindles can be exchanged at different times, thereby improving the freedom of machine operation.

Preferably, the ATCs are armless ATCs without a tool exchange arm.

The Armless ATC has the advantage of being inexpensive and requiring less space to install and has the disadvantage of longer tool exchange times compared to an ATC using tool exchange arms.

According to the above-described multiple spindle machine tool, the tool can be exchanged while machining is continued. Therefore, even if the tool exchange time is prolonged, it does not affect the total machining time, and the disadvantage of the armless ATC can be eliminated and the advantages can be utilized.

### Advantageous Effect of Invention

According to the multiple spindle machine tool of the present invention, each of a plurality of shutters, which is arranged to open and close when each spindle enters and exits between the machining chamber and the tool storage chamber, is provided for each spindle. Therefore, it is possible to prevent tool exchange malfunction due to cutting chips, and to improve the freedom of machine operation.

### BRIEF DESCRIPTION OF DRAWINGS

FIG. 1 is a perspective view illustrating one embodiment in which a multiple spindle machine tool according to the present invention has two spindles.

FIG. 2 is a perspective view of one spindle in a machining chamber and the other spindle in a tool storage chamber in the same embodiment.

### DESCRIPTION OF EMBODIMENTS

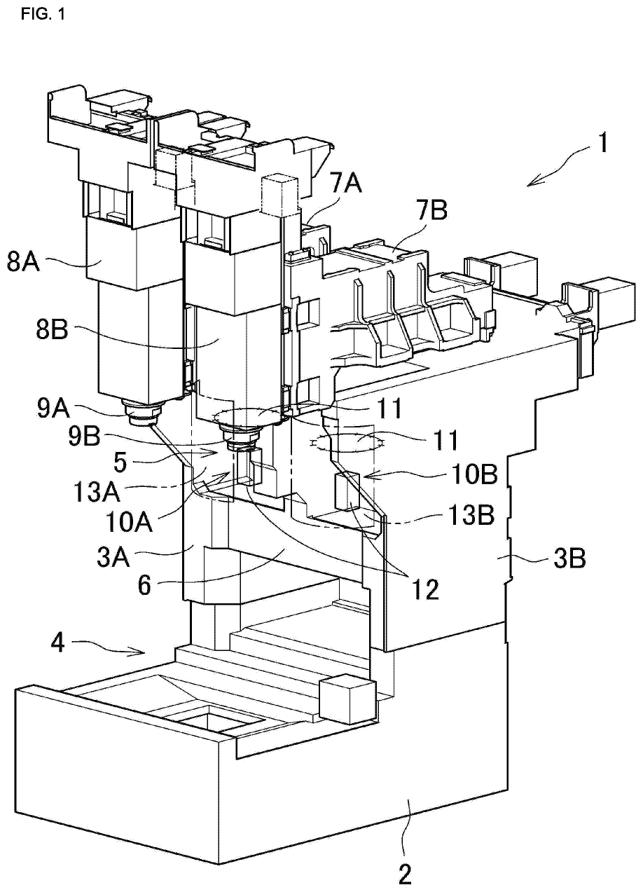

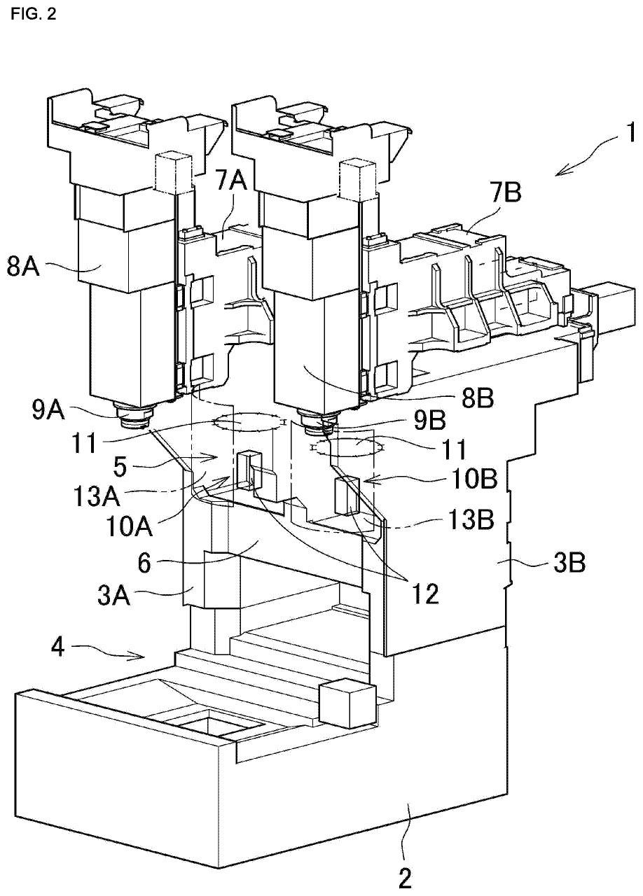

Hereinafter, the embodiments of the multiple spindle machine tool of the present invention will be described with reference to FIG. 1 and FIG. 2.

In the following description, the front side and the back side are referred to as the side of machining chamber and the side of the tool storage chamber, respectively. Likewise, the left and right sides are referred to as the right and left sides when viewed from the front to the rear.

A multiple spindle machine tool 1 have two spindles 9A and 9B arranged right and left in a parallel, and a left and right columns 3A and 3B is secured to the rear side of a bed 2 serving as a base.

The front side of the bed 2 is defined as a machining chamber 4, and a tool storage chamber 5 is provided on the rear side of the machining chamber 4 via a partition wall 6.

The machining chamber 4 is provided with a rotatable and laterally movable table (not shown) to support a workpiece, and machining can be efficiently performed by using alternately the two spindles 9A and 9B.

At the top end of the right and left columns 3A and 3B, the left and right saddles 7A and 7B are provided in a forward and backward movable manner.

On the right and left saddles 7A and 7B, left and right rams 8A and 8B are provided in an up and down mobable manner.

The left and right spindles 9A and 9B are mounted at the lower end of the left and right rams 8A and 8B.

A left and right magazines 10A and 10B to store tools for exchange is provided in the tool storage chamber (5) corresponding to the right and left spindles 9A and 9B.

Each of the magazines 10A and 10B includes a disc 11 which hangs and holds the tools around it and a motor 12 which rotates the disc 11.

Each of the magazines 10A and 10B constitutes an armless automatic tool changer (armless ATC), and the rotation of the disc (11) and the relative movement of the spindle 9A and 9B (relative movement of the saddles 7A and 7B and the rams 8A and 8B to move the spindles 9A and 9B) can be used to directly deliver and receive the tools without using a exchange arm between each of the spindles 9A and 9B and each of the magazines 10A and 10B.

FIG. 1 shows a state in which two spindles 9A and 9B are in standby in the machining chamber 4, and FIG. 2 shows a state in which the spindle 9A is in the machining chamber 4 and the spindle 9B is in the tool storage chamber 5.

The partition wall 6 is provided with an opening for passing through the spindles opened upwardly for which each of the spindles 9A and 9B enters and exits between the machining chamber 4 and the tool storage chamber 5, and a right and left shutters 13A and 13B corresponding to each of the spindles 9A and 9B, which are arranged to open and close the opening for passing through the spindles.

Each of the shutters 13A and 13B is normally in a closed position as shown by twe-dot chain line in the drawings and is temporarily set to an open position when necessary (moving to the left side of the drawings), so that each of the shutters 13A and 13B returns to the closed position immediately after the entry and exit of each of spindles 9A and 9B is completed.

Upper of each of the shutters 13A and 13B is open and, if each of the shutters 13A and 13B is in an open position, each of the spindles 9A and 9B can enter and exit between the machining chamber (4) and the tool storage chamber (5) without the left and right rams 8A and 8B interfering with the partition wall (6).

Each of the magazines 10A and 10B is disposed at a position facing from the right and left shutter 13A and 13B, and thus a left and right shutter 13A and 13B is provided corresponding to the left and right spindles 9A and 9B, so that the left and right spindles 9A and 9B can be moved to the delivery position of the left and right magazines 10A and 10B by putting the right and left shutters 13A and 13B in the open position.

According to the embodiment of the multiple spindle machine tool 1, the machining/tool exchange operation is performed, for example, as follows.

1. Machining in the machining chamber 4 is performed by the left spindle 9A and then the machining is completed.

At this time, the left shutter 13A is in the closed position, the right spindle 9B is in the standby position in the tool storage chamber 5, and the right shutter 13B is in the closed position.

2. After machining, the left shutter 13A is set to the open position, and the left spindle 9A is moved from the machining chamber 4 to the tool storage chamber 5.

Later, the left shutter 13A is set to the closed position.

At the same time, the right shutter 13B is set to the open position, and the right spindle 9B is moved from the tool storage chamber 5 to the machining chamber 4.

After this, the right shutter 13B is set to the closed position.

3. Machining is performed by the right spindle 9B in the machining chamber 4.

At the same time, in the tool storage chamber 5, a tool held by the left spindle 9A is replaced with a tool for exchange held in the left magazine 10A with the left ram 8A up and down.
The left shutter 13A and the right shutter 13B are maintained in the closed position.

4. In the machining chamber 4, machining by the right spindle 9B is continued and tool exchange of the left spindle 9A is completed in the tool storage chamber 5.

The left shutter 13A is set to the open position, and the left spindle 9A is moved from the tool storage chamber 5 to the machining chamber 4 and standby in the machining chamber 4.

Later, the left shutter 13A is set to the closed position.

Here, the movement of the left spindle 9A from the tool storage chamber 5 to the machining chamber 4 may be carried out until the machining by the right spindle 9B is completed, and the left spindle 9A may be held in the tool storage chamber 5. (when the machining by the right spindle 9B is completed, it is necessary to wait in the machining chamber 4.)

5. When the right spindle 9B finishes machining, the right shutter 13B is set to the open position, and the right spindle 9B moves from the machining chamber 4 to the tool storage chamber 5.

After this, the right shutter 13B is set to the closed position.

6. Machining by the left spindle 9A, which was waiting in the machining chamber 4, starts. In the tool storage chamber 5, a tool held by the right spindle 9B is replaced with a tool for exchange held in the right magazine 10B with the right ram 8B up and down.

The left shutter 13A and the right shutter 13B are maintained in the closed position.

7. By repeating the same operation as described above, the right and left spindles 9A and 9B can be alternately used for continuous machining while exchanging the tools.

In the above-described machining and tool exchange operation, each of the shutters 13A and 13B is normally maintained in the closed position, thereby preventing the cutting chip from entering the tool storage chamber 5 during machining and preventing the tool exchange malfunction due to the cutting chip.

In addition, the spindles 9A and 9B after the tool exchange may be held in the machining chamber 4 or may be held in the tool storage chamber 5, so that the spindles 9A and 9B waiting in the machining chamber 4 can be prevented from interfering with the workpiece and the machining area can be enlarged.

In addition, since each of the magazines (tool exchange device) 10A and 10B is provided in the tool storage chamber 5 corresponding to each of the spindles 9A and 9B, the tool exchange can be performed at different times with each of the spindles 9A and 9B, thereby improving the degree of freedom in machine operation.

Although the above-described embodiment described two spindles 9A and 9B, the number of the spindles can also be three or more.

The automatic tool changer may also be an ATC using a exchange arm rather than an armless ATC.

In the case of an armless ATC, the disadvantage of long tool exchange time of the armless ATC can be eliminated and the advantages of low cost and low installation space can be utilized, which is a preferred combination.

### REFERENCE SIGNS LIST

1: Machine tools
4: Machining chamber
5: Tool storage chamber
9A, 9B: left and right spindles
10A, 10B: Left and right magazines (automatic tool changer)
13A, 13B: left and right shutters

1. A multiple spindle machine tool, comprising:
a plurality of spindles;
a machining chamber;
a tool storage chamber;
a plurality of automatic tool changers (ATCs); and
a plurality of shutters, each of which is arranged to open and close when each of the plurality of spindles enters and exits between the machining chamber and the tool storage chamber,
wherein each ATC is corresponding to each of the plurality of spindles and each shutter is provided for each of the plurality of spindles.

2. The multiple spindle machine tool according to claim 1, wherein the ATC is an armless ATC without a tool exchange arm.
